(19) United States
(12) Patent Application Publication
(10) Pub. No.: US 2011/0280099 A1
(43) Pub. Date: Nov. 17, 2011

(54) MIXER

(75) Inventors: Henning KREIS, Ahnatal/Heckershausen (DE); Thomas Schill, Berkatal (DE)

(73) Assignee: ZEPPELIN REIMELT GMBH, Roedermark (DE)

(21) Appl. No.: 13/090,300

(22) Filed: Apr. 20, 2011

(30) Foreign Application Priority Data
Apr. 22, 2010 (DE) 10 2010 016 596.4

(51) Int. Cl. B01F 13/00

(52) U.S. Cl. 366/343

(57) ABSTRACT

A mixer including a rotatable mixing container including a container drive, a mixing head attached in the mixing container, a rotatably mounted mixing tool, and a tool drive to drive the mixing tool. The mixing tool includes a shaft and a frame arranged concentrically around the shaft. The shaft and the frame are interconnected by at least two circulating elements. The at least one shear pin is arranged on the frame and is configured to be guided during an operation by at least one shear groove disposed in the mixing head.

### CROSS-REFERENCE TO RELATED APPLICATION

This application claims benefit of and priority to German Patent Application No. 10 2010 016 596.4-23, filed on Apr. 22, 2010, the content of which Application is incorporated herein by reference.

The present disclosure relates to a mixer that includes a rotatable mixing container including a container drive, a mixing head attached in the mixing container, a rotatably mounted mixing tool, and a tool drive to drive the mixing tool.

Generic mixers of this type are known in numerous embodiments. They include, for example, a rotatable mixing container, a mixing tool rotatably mounted in the mixing container and a drive for the mixing tool. The mixing container can be pivoted from a vertical position into any other position by a container drive.

In operation, the mixing container of the mixer can be moved into a docking station provided for this purpose after introducing the material to be mixed. After the docking, the mixing container is pivoted from a vertical position into another position in which the actual mixing process takes place. The advantage in this procedure is that the mixing container can serve as a transport container for the material to be mixed within operation both of the unmixed material to be mixed and also of the ready-mixed material to be mixed. As a result, additional devices or conveying systems for conveying the unmixed material to be mixed or the ready-mixed material to be mixed are thereby eliminated.

Such mixers are predominantly used in applications in which a frequent product change takes place, for example, during the production of pigment mixtures, so-called master batches as well as mixtures of additives. These mixtures are used, for example, as additives to plastics for the production of most diverse end products such as, for example, containers for cosmetics, shampoo, and also window profiles or other technical profiles.

As a result of the need for a frequent change of products in these applications, the cleaning of the mixer between the actual mixing cycles acquires a particular importance. Depending on the type of product, cleaning times of up to 30 minutes are required in the present mixers. In this case, the essential components of the mixer in contact with product are the mixing head, the tool and the mixing container. In operating practice, however, neither the mixing head as a stationary machine nor the tool that can only be dismounted with some effort, can be inserted in a suitable cleaning apparatus. Consequently, only a cleaning on site by mechanical disposal and removal of product residue, for example, by vacuum cleaners comes into consideration. However, as a result of the appreciable size of the mixing container in some cases, cleaning in suitable stations is very laborious.

The present disclosure provides for a mixer which can be cleaned simply, rapidly and inexpensively.

The present disclosure thus relates to a mixer that includes a rotatable mixing container including a container drive, a mixing head attached in the mixing container, a rotatably mounted mixing tool, and a tool drive to drive the mixing tool. The mixing tool including a shaft and a frame arranged concentrically around the shaft. The shaft and the frame are interconnected by at least two circulating elements. At least one shear pin is arranged on the frame and is configured to be guided during an operation by at least one shear groove disposed in the mixing head.

According to the present disclosure, the mixing tool includes a shaft, or hub, and a frame arranged concentrically around the hub, wherein the hub and the frame are interconnected by at least two circulating elements. Further included is at least one shear pin arranged on the frame, which shear pin can be guided during operation by at least one shear groove disposed on the mixing head.

Such a configuration of the mixing tool allows a reduction of the diameter of the mixing tool with the same shear effect. The reduction of the diameter of the mixing tool is accompanied by a reduction of the area in contact with product, that is, the area to be cleaned, so that a mixer provided with such a mixing tool is better to clean than a mixer having a conventional mixing tool.

According to an embodiment of the mixer of the present disclosure, the hub, or shaft, of the mixing tool can be received in a receptacle, or groove, driven by the tool drive and capable of being operated without tools. As a result, the mixing tool can be removed simply from the tool drive or the mixing head. Complex dismantling of the mixing tool with a special tool can therefore be omitted. In addition, as a result of the reduced size, compared with conventional mixing tools, the tool can be cleaned in a simple manner using usual apparti such as, for example, steam jet air ejectors or cleaning machines.

According to another embodiment of the present disclosure, the at least one shear pin is mounted on the frame to produce a shear effect in the material to be mixed.

According to another embodiment of the present disclosure, the frame of the mixing tools is configured as a circular ring and the circulating elements may be configured in a sickle shape in a plane perpendicular to the axis of rotation of the hub. The circulating elements may be formed in the manner of a screw band. A mixing tool formed in this manner is capable of producing a sufficient acceleration of the material to be mixed and of achieving the necessary desired shear effect in the material to be mixed despite the reduced circumferential speed.

Other aspects of the present disclosure will become apparent from the following descriptions when considered in conjunction with the accompanying drawings.

### BRIEF DESCRIPTION OF THE DRAWINGS

FIG. 1 shows a perspective view of an embodiment of a mixer, according to the present disclosure.

FIG. 2 shows a perspective view of an embodiment of a mixing tool, according to the present disclosure.

FIG. 3 shows a cross-sectional view of a mixing container with mixing head placed thereon of the mixing tool of FIG. 2.

### DETAILED DESCRIPTION

In the following description, terms such as top, bottom, left, right, front, and behind are exemplary representations and positions of the mixer and other parts shown in the respective Figures. These terms are not to be understood as being restrictive. That is, these term references can change, for example, due to different working positions or a mirror-symmetrical design.

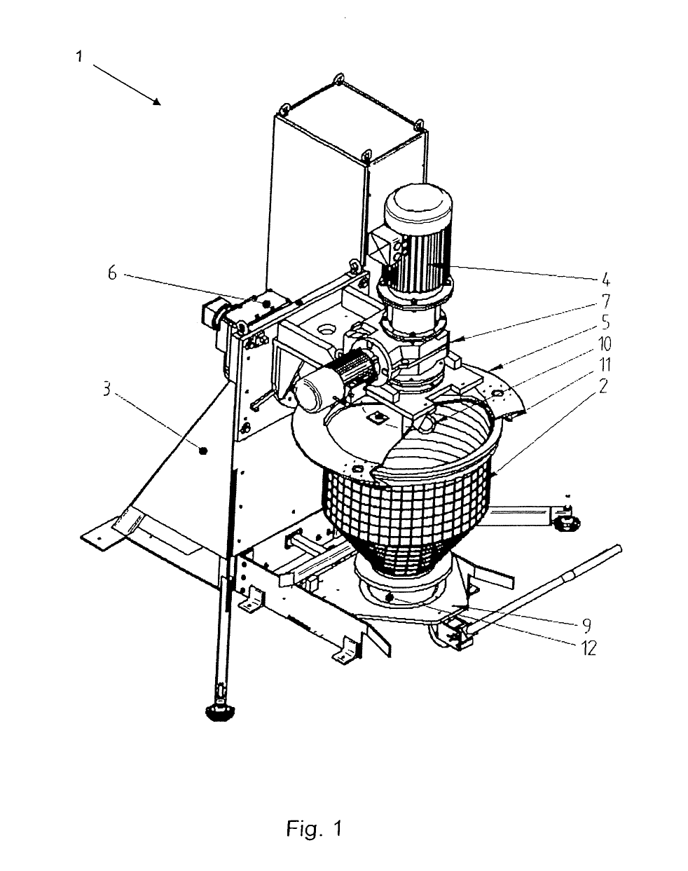

As shown in FIG. 1, a mixer 1 includes a mixing head 5, a mixing container 2 on which the mixing head 5 can be placed and by which mixing head 5 the mixing container 2 can be closed. Also shown is a stand 3 on which the mixing head 5 is held. On the side of the mixing head 5 facing the mixing container 2, a mixing tool 10 is rotatably mounted, which tool 10 is fastened by a tool drive 4 on the side of the mixing head 5 facing away from the mixing container 2.

The mixing container 2 may be mounted on an underframe 9 which may be provided with a closure 12 by which closure 12 an outlet attached to the underside of the mixing container 2 can be closed.

Two movable arms 11 which embrace the mixing container 2 circumferentially are furthermore provided on the stand 3 for docking the mixing container 2, and by which arms 11 the mixing container 2 can be fixed on the mixing head 5. When the mixing container 2 is docked onto the mixing head 5, it can be pivoted in this position by a pivoting drive 6 from a vertical position into a position about its longitudinal axis.

In the pivoted mixing position, the mixing container 2, including mixing head 5, can be rotated about its longitudinal axis by a container drive 7. At the same time, the tool 10 is rotated in the mixing head 5 with the aid of the tool drive 4 in a direction opposite to the direction of rotation of the mixing container 2 for processing the material to be mixed in the mixing container 2.

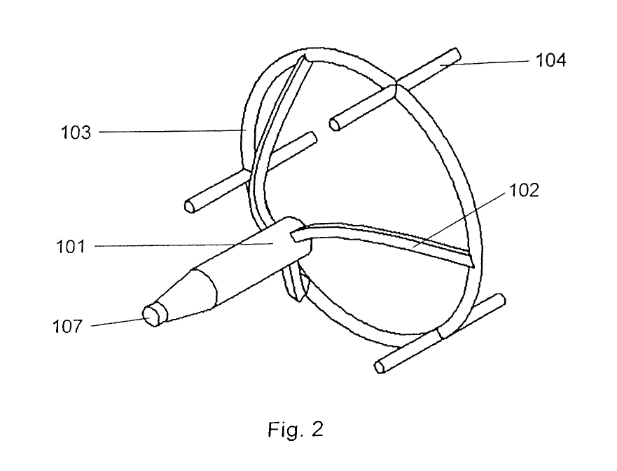

FIG. 2 shows an embodiment of a mixing tool 10, according to the present disclosure. This tool 10 includes a shaft 101, a frame 103 arranged concentrically around the shaft 101, which is configured as a circular ring. It is also within the scope of the present disclosure that the frame 103 is configured as a polygon, for example, a triangle or a tetragon, arranged concentrically around the shaft 101. The frame 103 and the shaft 101 are interconnected by at least two circulating elements 102. These circulating elements 102 may be configured as sickle-shaped metal strips which extend perpendicular to the axis of rotation of the shaft 101 away from the shaft 101 towards the frame 103. The circulating elements 102 may be twisted in a helical shape, that is, in the manner of a screw band. In addition, the circulating elements 102 may be bent in the direction of the axis of rotation of the shaft 101. This ensures the production of a homogeneous environmental flow of material to be mixed in the mixing material container 2.

The mixing tool 10 is mounted on the mixing head 5 and the tool drive 4 by the shaft 101 which is formed with an attachment 107 at its end remote from the circulating elements 102. The attachment 7 may be configured so that it can be received in a receptacle 106 of the tool drive 4 which can be operated without tools. The attachment 107 of the shaft 101 and the receptacle 106 of the tool drive 4 may be configured in the manner of a coupling of a quick release device, such as is common in drilling tools, for example.

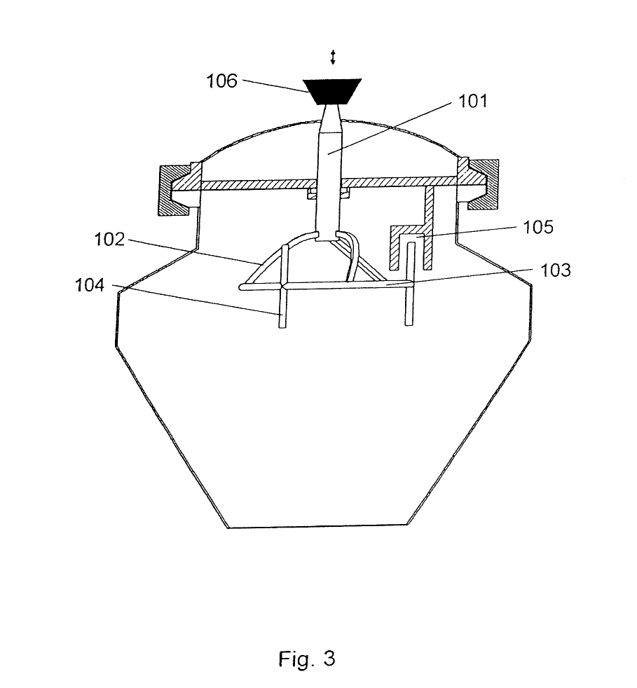

In order to further reduce the area of the mixer 10 in contact with product and therefore requiring cleaning, the opening of the mixing container 2 may be configured to be reduced in size. For example, the region of the lateral surface of the mixing container near the mixing head 5 is configured to be conically tapered, as shown in FIG. 3. It is within the scope of the present disclosure that the lateral surface may be tapered in the direction of the mixing head 5.

As is further shown in FIGS. 2 and 3, at least one shear pin 104 is attached to the frame 103, which during operation can be guided by at least one receptacle, or shear groove 105, held on the mixing head 5. As a result, a sufficient shear effect of the arrangement is achieved despite the reduced diameter of the mixing tool 10.

The present disclosure is not restricted to the exemplary embodiment described which can be modified in manifold ways. It is understood that the various features of the mixer, according to the present disclosure, can be applied in combinations other than those shown and described. Although the present disclosure has been described and illustrated in detail, it is to be clearly understood that this is done by way of illustration and example only and is not to be taken by way of limitation. The scope of the present disclosure is to be limited only by the terms of the appended claims.

1. A mixer (1), comprising a rotatable mixing container (2), a container drive (7) for the mixing container (2), a mixing head (5) which can be attached in the mixing container (2), with a rotatably mounted mixing tool (10) and a tool drive (4) for the mixing tool (10), characterised in that the mixing tool (10) comprises a shaft (101) and a frame (103) arranged concentrically around the shaft (101), wherein the shaft (101) and the frame (103) are interconnected by at least two circulating elements (102) and wherein at least one shear pin (104) is arranged on the frame (103), which can be guided during operation by at least one shear groove (105) disposed on the mixing head (5).

2. The mixer (1) according to claim 1, characterised in that the frame (103) is configured as a circular ring.

3. The mixer (1) according to claim 1 or 2, characterised in that at least one shear pin (104) is mounted on the frame (103).

4. The mixer (1) according to any one of the preceding claims, characterised in that the circulating elements (102) are configured in a sickle shape in a plane perpendicular to the axis of rotation of the hub (101).

5. The mixer (1) according to any one of the preceding claims, characterised in that the circulating elements (102) are configured in the manner of a screw band.

6. The mixer (1) according to any one of the preceding claims, characterised in that the circulating elements (102) are configured to be bent in the direction of the axis of rotation of the shaft (101).

7. The mixer (1) according to any one of the preceding claims, characterised in that the shaft (101) of the mixing tool (10) can be received in a receptacle (106) driven by the tool drive (4) which can be operated without tools.

8. The mixer (1) according to any one of the preceding claims, characterised in that the region of the lateral surface of the mixing container (2) near the mixing head (5) is configured to be tapered in the direction of the mixing head (5).

9. The mixer (1) according to any one of the preceding claims, characterised in that the region of the lateral surface of the mixing container (2) near the mixing head (5) is configured to be conically tapered.
